(19) United States
(12) Patent Application Publication
(10) Pub. No.: US 2008/0010076 A1
(43) Pub. Date: Jan. 10, 2008

(54) System and method for creating dynamic electronic publications

(76) Inventors: Michael Brent McMahon, Atlanta, GA (US); Donald Francis Willis JR., Atlanta, GA (US); Daniel Jon Gonzalez, Decatur, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/657,671

(22) Filed: Jan. 24, 2007

Related U.S. Application Data
(60) Provisional application No. 60/762,102, filed on Jan. 25, 2006.

(51) Int. Cl. G06Q 30/00

(52) U.S. Cl. 705/1; 705/14

(57) ABSTRACT

A method for creating a dynamic electronic publication comprises importing one or more data assets into a publication design environment and identifying one or more features associated with one or more of the data assets. Each data asset and any features associated with each data asset are converted to a browser-readable file format and arranged based on a user-defined layout. A browser-compatible file map of the data assets is created based to the user-defined layout. An electronic publication associated with the file map is generated. The electronic publication includes browser-readable code that, when executed by a web-browser, displays the one or more data assets and any features associated with each data asset in accordance with the user-defined layout.

This application claims priority to and the benefit of the filing date of U.S. Provisional Patent Application No. 60/762,102, filed Jan. 25, 2006, which is herein incorporated by reference in its entirety.

### TECHNICAL FIELD

The present disclosure relates generally to dynamic electronic publications and, more particularly, to a system and method for creating dynamic electronic publications.

### BACKGROUND

Print, television, and radio media have historically been the dominant mode of advertising and marketing of products and services. With the increasing popularity of mobile communication electronics and widespread access to the Internet via a wide range of devices, audiences have become less dependent on these traditional forms of media. Accordingly, advertisers and media outlets have adapted by providing content in a variety of electronic media formats, particularly via the Internet.

Most electronic publications derived from print-based media typically include electronic text or photocopy-type version of the print version. These types of publications typically do not support video or audio content, which limits the advertising options to still images or text ads. In some cases, these photo-copy type publications may allow users to select embedded links, which accesses and plays video or audio clips using a third-party, vendor-based multimedia player. These executable programs often require users to download (and, in some cases, purchase) the player in order to view the video clip. This may be problematic for users of handheld devices that may not have the processing capabilities required to install or run these players. Moreover, because these advertisements are often embedded as links within the document, users may be inclined to simply avoid the clips altogether, which may ultimately affect the desirability of the electronic publication as an advertising medium. Thus, in order to provide users and advertisers with a seamless, dynamic, electronic publication medium, a method for producing interactive electronic publications that uses a single, widely available electronic medium, and lends itself to an endless array of wired and wireless devices, may be required.

One system for creating and distributing electronic publications is described in U.S. Patent Application Publication No. 2005/0144565 (“the '565 publication”) to Hemmings. The '565 publication describes creating an electronic version of a print publication. The electronic publication includes a self-executable file that includes software code and content data for outputting an electronic replica of a print media document. The self-executable file includes software code that addresses the processing device directly, thereby removing the need for third-party multimedia players or a web-browser. The self-executable file provides an interface that allows a user to read an electronic version of the publication. The interface provides a page-turn feature that provides a page-turning effect when the reader of the electronic publication prompts the software to turn the page.

Although the '565 publication may provide a method for delivering an electronic version of printed material for use on a computer system, it may have several disadvantages. First, because the method of the '565 publication only copies the content and advertisement data from the printed publication and adapts the data to be used with a self-executable software application, it may not allow publishers and/or advertisers to merge different media types into the same publication. Furthermore, because the electronic publication created using the methods of the '565 publication is adapted for use only with the self-executable file for which it was developed; users of computer systems who do not have the necessary permission to install or run these executable files may not be able to view the document.

In addition, although electronic publications created by the method of the '565 publication may provide the advertisements available in the printed publication, it does not include a data collection feature that allows users to record user interaction data associated with the publication. As a result, advertisers that rely on audience metrics to determine a target audience may not be able to ascertain whether their advertisement is generating interest with the readers of the publication. By not providing a mechanism to measure user interaction with the publication, advertisers and publishers may not be able to determine the effectiveness of an ad campaign.

The present disclosure is directed to overcoming one or more of the shortcomings set forth above.

### SUMMARY OF THE INVENTION

In accordance with one aspect, the present disclosure is directed toward a method for creating a dynamic electronic publication. The method comprises importing one or more data assets into a publication design environment and identifying one or more features associated with one or more of the data assets. Each data asset and any features associated with each data asset may be converted to a browser-readable file format and arranged based on a user-defined layout. A browser-compatible file map of the data assets may be created based to the user-defined layout. An electronic publication associated with the file map may be created. The electronic publication may include browser-readable code that, when executed by a web-browser, displays the one or more data assets and any features associated with each data asset in accordance with the user-defined layout.

According to another aspect, the present disclosure is directed toward a method for generating interactive electronic publications. The method comprises importing one or more data assets and identifying one or more features associated with one or more of the data assets. Each data asset and any features associated with each data asset may be converted to a browser-readable file format and arranged based on a user-defined layout. A data collection feature may be embedded within one or more of the data assets, wherein the data collection feature is configured to collect data indicative of a user interaction with a designated portion of the data asset. An electronic publication may be generated that, when executed by a web-browser, displays the one or more data assets and any features associated with each data asset in accordance with the user-defined layout.

In accordance with yet another aspect, the present disclosure is directed toward a method for creating an electronic publication. The method may comprise importing one or more data assets associated with a print publication and one or more electronic advertisements into a publication design environment. One or more of the data assets and one or more of the electronic advertisements may be arranged in accordance with a user-defined layout. One or more interactive features may be inserted within the arrangement of data assets and electronic advertisements. The arrangement may be converted into a browser-readable data file. A browser-compatible file map may be created that includes the arrangement of data assets and electronic advertisements in accordance with the user-defined layout. An electronic publication associated with the file map may be generated, the electronic publication including browser-readable code that, when executed by a web-browser, displays the one or more data assets and any features associated with each data asset in accordance with the user-defined layout.

### BRIEF DESCRIPTION OF THE DRAWINGS

FIG. 1 provides a block diagram illustrating an exemplary disclosed electronic publications generation and distribution network in accordance with the disclosed embodiments;

FIG. 2 provides a schematic of an exemplary disclosed system in which processes and methods consistent with certain disclosed embodiments may be performed;

FIG. 3 provides a block diagram illustrating an exemplary process flow for generating an electronic publication;

FIG. 4 provides a flowchart depicting an exemplary method for creating an electronic publication; and

FIG. 5 provides a flowchart depicting an exemplary method for collecting user interaction data associated with an electronic publication.

### DETAILED DESCRIPTION

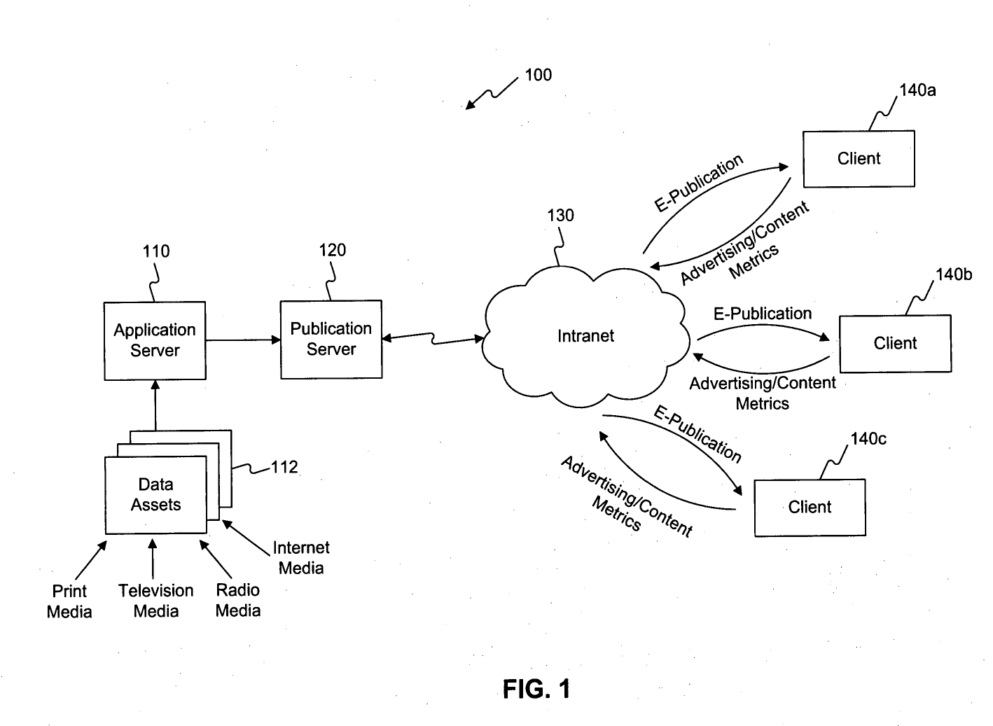

FIG. 1 illustrates an exemplary system 100 for generating and distributing electronic publications. Publication, as the term is used herein, refers to information for use, display, creation, or generation in any format or media. Non-limiting examples of publications include files or data elements that can be processed and presented on any display device (e.g., computer screens, television monitors, LCD or plasma display devices, cell phone displays, PDAs, or mobile display devices). Accordingly, publication refers to any file or media type that can be created, manipulated, customized, or processed to be implemented in connection with any suitable display medium. System 100 may include one or more components or subsystems that cooperate to create and deliver electronic publications to one or more users. For example, system 100 may include an application server 110, a publication server 120, a communication link 130, and one or more clients 140a-c. The components and subsystems listed above are exemplary only and not intended to be limiting. It is contemplated that additional, fewer, and/or different components may be included within system 100.

Publication server 120 may include any type of computer system for storing and distributing electronic publications. Publication server 120 may be communicatively coupled to application server 110 and configured to receive electronic publications from application server, store the electronic publications, and distribute the electronic publications to one or more clients. For example, publication server 120 may include a web server coupled to a communication network (e.g., the Internet) that provides the electronic publications to customers and subscribers. According to one embodiment, publication server 120 may include a kiosk-type distribution server that receives orders for electronic publications from a customer and allows the user to download the publication as part of a purchase transaction.

Communication link 130 may include any network that provides communications between each publication server 120 and one or more subscribers, such as clients 140a-c. For example, communication link 130 may communicatively couple publication server 120 to one or more client devices 140a-c across a wired or wireless networking platform such as, for example, the Internet. Alternatively and/or additionally, communication link 130 may include one or more broadband communication platforms appropriate for communicatively coupling publication server 120 to one or more client devices 140a-c such as, for example, cellular, Bluetooth, microwave, point-to-point wireless, point-to-multipoint wireless, multipoint-to-multipoint wireless, satellite, or any other type of communication network.

Clients 140a-c may each embody an electronic device that includes any type of standard web-browser or browser compatible reader. Clients 140a-c may be configured to execute a browser-readable electronic publication created using the methods described below. For example, clients 140a-c may each include a computer system, a handheld communication device (e.g., browser-enabled cell phone, personal data assistant (PDA), etc.), a browser-enabled television system, cable box, or any other electronic device that supports the use of a web-browser. It is contemplated that clients 140a-c may include any device that includes a processor, a memory device coupled to the processor for storing computer-readable instructions, and a display device coupled to the processor for outputting data from the processor.

Clients 140a-c may be communicatively coupled to one or more other clients and/or publication server 120. Accordingly, clients 140a-c may each be adapted to communicate data with publication server 120. This data may include advertising and content metrics gathered in connection with a user interaction with the electronic publication.

Application server 110 may include hardware and/or software elements adapted to create a browser-readable electronic publication. Application server 110 may include, for example, any type of computer system that executes software for performing processes and functions for importing media data files; arranging the media data files based on a user input; adding, removing, and/or modifying effects and features associated with the media files; converting the media files to a browser-readable format for display using a web-browser; and storing the data files in a user-specified directory.

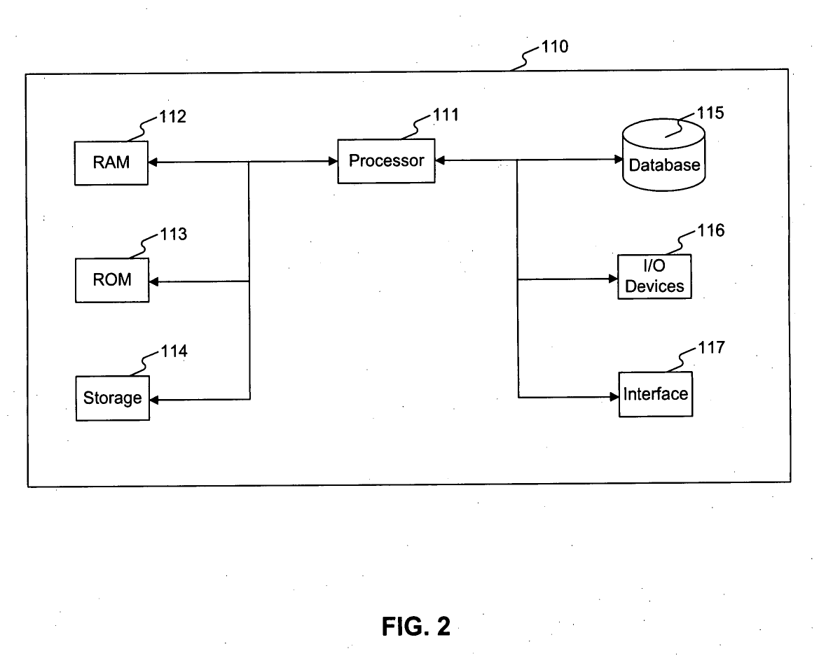

Application server 110 may include any type of processor-based system on which processes and methods consistent with the disclosed embodiments may be implemented. For example, as illustrated in FIG. 2, application server 110 may include one or more hardware and/or software components configured to execute software programs, such as software for importing data assets, arranging the data assets according to a user defined layout, adapting the data assets to conform to a browser-readable format, adding or inserting animations and other effects within the data assets, and rendering the data assets to produce an electronic publication in a browser readable format, without requiring the use of third party multimedia players. Data asset, as the term is used herein, refers to any type of electronic media file such as, for example, electronic video files (e.g., MPEG, AVI, RealVideo, WMV, etc.), audio files (e.g., MP3, WAV, WMA, BWF, etc.), text files (e.g., DOC, RTF, TXT, etc.), or image files (e.g., PDF, TIFF, BMP, JPEG, PMG, RAW, SVG, etc.). Data assets 112 may be adapted from one or more media types such as, for example, print media (e.g., newspapers, magazines, textbooks, advertising catalogs, etc.), video media (e.g., television (cable, broadcast, satellite, etc.), Internet, etc.), audio media (e.g., radio (broadcast, satellite, etc.), or Internet media.

Application server 110 may include any device adapted to execute software. For example, application server may include any device that includes a processor, memory, and a display. As such, application server 110 may include a computer or other processing device such as, for example, a desktop or laptop computer, a mainframe, a handheld processing device (e.g., cell phone, PDA, etc.), a processor-enabled cable box or television set, a video game console, or any other device that includes a processor, memory, and display device.

Application server 110 may include one or more hardware components such as, for example, a central processing unit (CPU) 111, a random access memory (RAM) module 112, a read-only memory (ROM) module 113, a storage 114, a database 115, one or more input/output (I/O) devices 116, and an interface 117. Alternatively and/or additionally, application server 110 may include one or more software components such as, for example, a computer-readable medium including computer-executable instructions for performing methods consistent with certain disclosed embodiments. It is contemplated that one or more of the hardware components listed above may be implemented using software. For example, storage 114 may include a software partition associated with one or more other hardware components of application server 110. Application server 110 may include additional, fewer, and/or different components than those listed above. It is understood that the components listed above are exemplary only and not intended to be limiting.

CPU 111 may include one or more processors, each configured to execute instructions and process data to perform one or more functions associated with application server 110. As illustrated in FIG. 2, CPU 111 may be communicatively coupled to RAM 112, ROM 113, storage 114, database 115, I/O devices 116, and interface 117. CPU 111 may be configured to execute sequences of computer program instructions to perform various processes, which will be described in detail below. The computer program instructions may be loaded into RAM for execution by CPU 111.

RAM 112 and ROM 113 may each include one or more devices for storing information associated with an operation of application server 110 and/or CPU 111. For example, ROM 113 may include a memory device configured to access and store information associated with application server 110, including information for identifying, initializing, and monitoring the operation of one or more components and subsystems of application server 110. RAM 112 may include a memory device for storing data associated with one or more operations of CPU 111. For example, ROM 113 may load instructions into RAM 112 for execution by CPU 111.

Storage 114 may include any type of mass storage device configured to store information that CPU 111 may need to perform processes consistent with the disclosed embodiments. For example, storage 114 may include one or more magnetic and/or optical disk devices, such as hard drives, CD-ROMs, DVD-ROMs, or any other type of mass media device.

Database 115 may include one or more software and/or hardware components that cooperate to store, organize, sort, filter, and/or arrange data used by application server 110 and/or CPU 111. For example, database 115 may include a library of data assets for use in an electronic publication, layout files associated with an electronic publication, electronic advertisements, electronic publication templates, historical advertising metrics associated with particular advertisements, or any other data associated with electronic publishing. CPU 111 may access the information stored in database 115 in order to generate a interactive electronic publications. CPU 111 may also execute software that analyzes advertising metrics associated with particular electronic publications to determine reader trends and evaluate an advertisement's effectiveness in the particular publication. This data may then be reported to one or more subscribers (e.g., the advertiser or publisher of the electronic publication). It is contemplated that database 115 may store additional and/or different information than that listed above.

I/O devices 116 may include one or more components configured to communicate information with a user associated with application server 110. For example, I/O devices may include a console with an integrated keyboard and mouse to allow a user to input parameters associated with application server 110. I/O devices 116 may also include a display including a graphical user interface (GUI) for outputting information on a monitor. I/O devices 116 may also include peripheral devices such as, for example, a printer for printing information associated with application server 110, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 117 may include one or more components configured to transmit and receive data via a communication network, such as the Internet, a local area network, a workstation peer-to-peer network, a direct link network, a wireless network, or any other suitable communication platform. For example, interface 117 may include one or more modulators, demodulators, multiplexers, demultiplexers, network communication devices, wireless devices, antennas, modems, and any other type of device configured to enable data communication via a communication network.

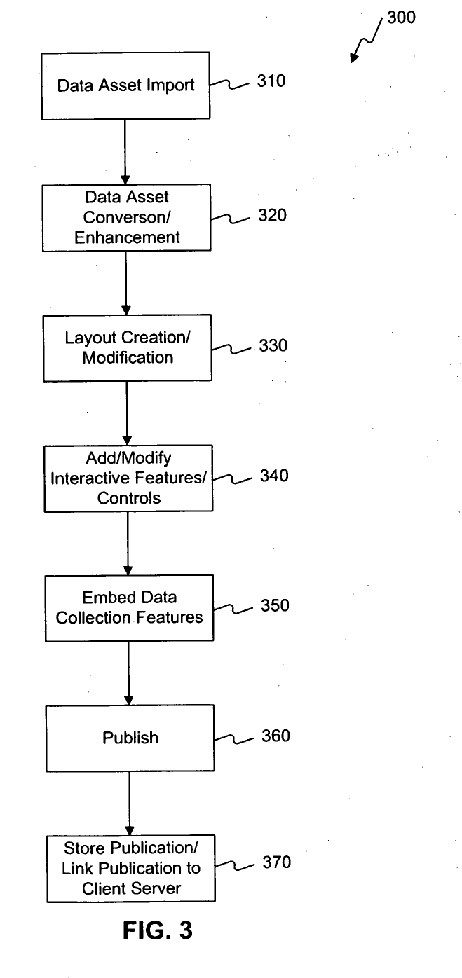

Application server 110 may include software that, when executed by CPU 111, may be configured to provide a publication design environment that allows users to import one or more data assets into the design environment, arrange the data assets to generate a layout of the electronic publication, add or modify interactive features associated with each data asset, and convert the data asset and any features associated therewith to a browser compatible format for display on a standard web browser, without requiring the use of third party multimedia players or other software. FIG. 3 provides a block diagram 300 illustrating an exemplary process flow for creating an electronic publication using electronic publication software associated with application server 110.

As illustrated in FIG. 3, CPU 111 associated with application server 110 may execute publication software that imports one or more data assets into a publication design environment (Step 310). For example, application server 110 may be communicatively coupled to one or more storage devices and may receive, collect, and/or import one or more data assets 112 from the one or more storage devices. According to one embodiment, application server 110 and/or publication software may have access to a data asset database and may be configured to import data assets 112 via the data server or asset database. Alternatively and/or additionally, application server 110 may be configured to receive data assets 112 directly from a user, via an electronic media interface or storage device, such as a media card, disk drive, etc.

Once data assets 112 have been imported into publication design environment, publication software may convert the data assets into one or more browser compatible file formats (Step 320). For example, publication software may convert video data asset to a browser-executable file format, such as the flash file format or other vector-based graphical data file that is viewable using a web-browser. Similarly, publication software may convert audio data files into a browser-executable file format, such as the MP3 file format or other audio file that may be played using a standard web-browser (without requiring a third party multimedia player). It is contemplated that publication software may include various audio and video codecs to convert various types of data assets to browser-compatible formats. For example, publication software may include a flash codec that automatically converts various types of video files to a flash or other vector-based graphical file that may be displayed on a web-browser.

In addition to converting the data asset into browser compatible file formats, each data asset may be enhanced for display with on a particular client device. For example, publication software may convert and/or enhance attributes associated with a video data asset for display on a particular size and type of display monitor. It is contemplated that, based on output settings provided by a user, these enhancements may be adaptable, depending upon the size and type of client device that the publication is to be displayed on.

Application server 110 and software associated therewith may create and/or modify the format and design of the electronic publication based on a user-defined layout (Step 330). Publication software may provide an interface that allows users to drag-and-drop the data assets within the publication environment to generate a graphical representation of the format and layout of the electronic publication. Layouts may be created using certain pre-formatted layout templates, which may correspond to electronic versions associated with conventional media formats. For example, layout templates for electronic versions of newspapers, magazines, advertisement catalogs, etc. may be used to import features or structural formats typically associated with the publication. Publication software may modify certain features and formats associated with the electronic publication based on user inputs to the publication design environment.

During the publication layout and design phase, interactive features and controls associated with each data asset may be added or modified, based on user commands (Step 340). For example, users may import text and graphics associated with a print publication. According to one embodiment, these features may include graphical animations, pop-up text boxes, interactive captions, or other types of features to enhance the viewing experience of the electronic publication.

Alternatively and/or additionally, certain features may be embedded that collect data associated with a reader's interaction with the publication (Step 350). For example, event timers may be inserted for gathering user interaction data associated with one or more data asset. According to one embodiment, timers associated with each data asset may be inserted measure how long a user interacts with a certain feature of the data asset. In the case of text or images, timers may be inserted to measure a duration that a user views a particular page of the text or image. For advertisements, timers may be embedded to measure the time that a user views (or interacts, in the case of an interactive ad) the advertisement. This data may be stored and delivered to an advertiser and/or publisher.

Once the layout has been completed and any features associated with each data asset have been added and finalized, publication software may publish the document in response to a publication command provided by a user (Step 360). During the publication process, publication software may create a browser readable file map associated with the publication, the file map containing the data assets, features, and browser-executable code for displaying the electronic publication using a web-browser. Additionally, publication software may convert any data asset, features, and advertisements into a format that may be displayed using only a web-browser, without requiring the use of third party multimedia players or proprietary executable files. Once the publication software has created the electronic publication, the publication may be stored, uploaded, and/or linked to publication server or other storage medium (Step 370), which may provide access to one or more subscribers or designated users of the electronic publication.

It is contemplated that the electronic publication may be formatted to utilize substantially all of the display of a particular electronic device for which it is designed. For example, publication software may generate the electronic publication in multiple formats, allowing the user to select which type of display format is desired (e.g., handheld display, laptop display, widescreen display, etc.). Alternatively and/or additionally, publication software may embed auto-detection and auto-format features that determine, upon initialization of the electronic publication, what type of display format is supported. Electronic publication may be adapted to format each feature or view associated with the electronic publication, in accordance with the supported display device.

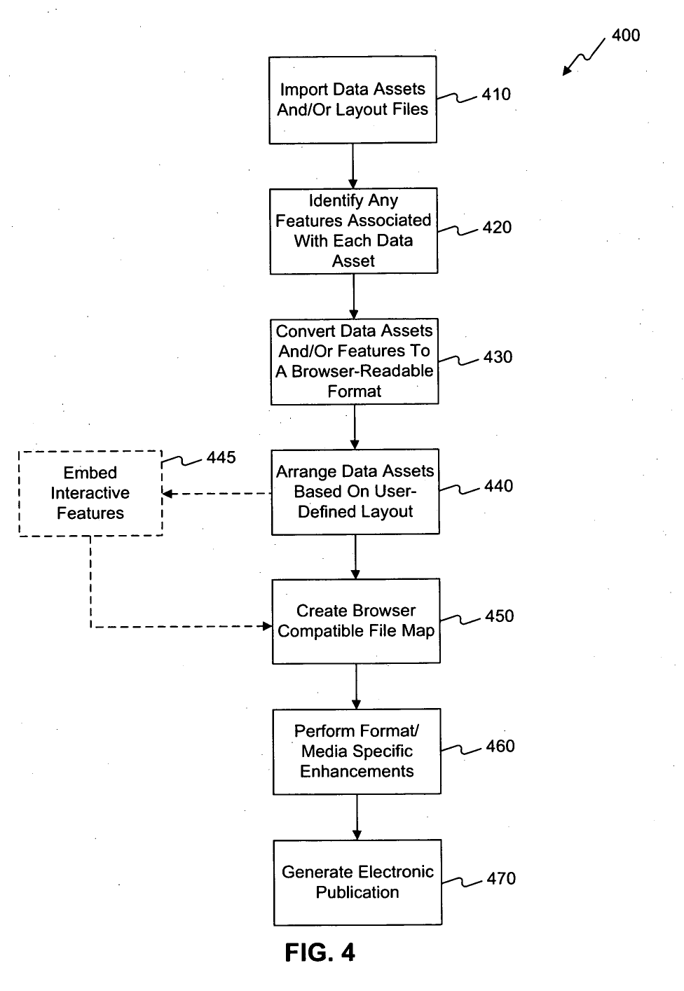

Processes and method consistent with the disclosed embodiments allow users to create electronic publications using data assets associated with different media types by converting the data to a browser-compatible file structure that uses existing web-browser technology to display the electronic publication. As a result, users may be able to generate electronic publication for use on display devices, without requiring third party or proprietary multimedia software. By providing a tool to generate interactive electronic publications that are displayed using only web-browser technology, readers may not require specialized media players to view mixed-media publications. Similarly, advertisers may not be required to re-format television or internet video ads into a browser-readable format prior to publication, potentially saving significant time and resources in creating electronic publications. FIG. 4 illustrates a flowchart 400 for creating interactive electronic publications in accordance with the disclosed embodiments.

As illustrated in FIG. 4, publication software may import data assets and/or layout files from one or more data asset directories (Step 410). Any features associated with a particular data asset may be identified (Step 420). These features may include any type of embedded animation, graphical pop-up displays, or any other type of feature that may be associated with a data asset (such as animation provided with still image files that together create an interactive image file).

Once data assets have been imported into the publication software and features associated with each data asset have been identified, each data asset and features associated therewith may be converted to a browser readable format (Step 430). For example, video files supplied in a third-party video format (e.g., MPEG, AVI, WMV, etc.) may be converted to a format suitable for viewing using only a web-browser or browser associated technology such as flash video or some other appropriate type of browser-displayable format.

Publication software may arrange the data assets based on a user-defined layout commands (Step 440). A user-defined layout may be interactively provided by the user when a user arranges data assets within a graphical user interface provided by the publication software. Alternatively and/or additionally, a user may provide an electronic layout template that includes a desired layout format associated with the electronic publication.

During the layout phase, publication software may embed interactive features for one or more data assets, based on user defined commands (Step 445). For example, users of the publication software may wish to embed certain data collection features associated with a particular data asset. Accordingly, publication software may provide users with a palette of embedded functions that may be inserted into one or more data assets. In addition to data collection features, these features may include text effects, animation effects associated with graphical images, pop-up display effects associated with video or image assets, or any other type of user interactive feature that may enhance the presentation of content or advertisement data. According to one embodiment, links to other electronic publications may be provided as a feature associated with an advertisement. For instance, user may embed an interactive link within an advertisement that allows a reader to gather more information associated with a particular ad. For example, readers may be able to interactively select a product catalog that features an entire product line associated with a company in an advertisement. Alternatively, readers may be able to access an electronic publication associated with a car to obtain detailed information about a particular car advertised in an automotive ad.

Once the layout has been created and finalized, publication software may create a browser-compatible file map in response to a user command (Step 450). Additionally, publication software may perform format and/or media-specific enhancements on one or more data assets and/or features associated with the layout (Step 460). These enhancements may include color palette modifications, size/shape enhancements for a particular display format, re-imaging of video or image files for display on large and small format display devices, or any other type of data enhancement corresponding to a user-specified display format or image quality. Once the file map has been created and any format-specific enhancements have been made, an interactive electronic publication may be generated (Step 470). As explained, the interactive electronic publication may be formatted for display using standard web-browser technology, without requiring any third party multimedia players.

Once the electronic publication has been generated, it may be distributed to one or more subscribers. For example, the electronic publication may be sent directly to one or more subscribers via e-mail. Alternatively, the electronic publication may be posted to publication server 120 accessible by the Internet. According to one exemplary embodiment, publication server may be a web server associated with a particular publisher allowing customers to order subscriptions of the electronic publication.

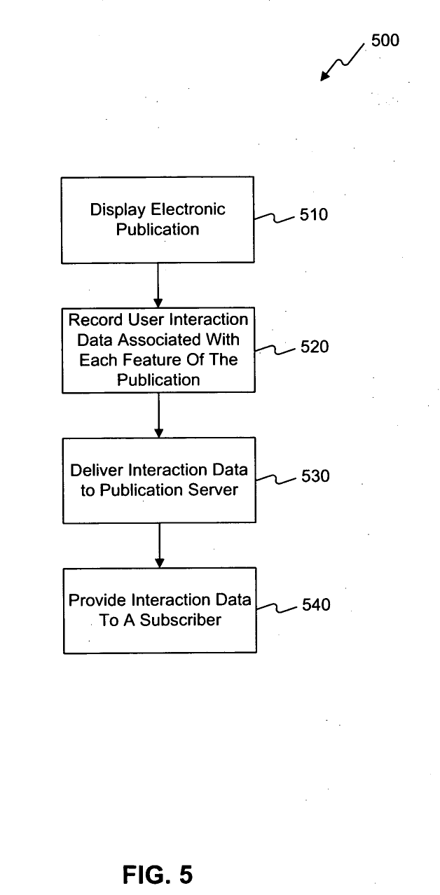

Methods consistent with the disclosed embodiments allow electronic publications to collect user data associated with the user's interaction with the electronic publication. For example, as explained, electronic publications may include features that collect user interaction data associated with data assets contained within the electronic publication. When users view the electronic publication, one or more data records may be created within the file map that collects usage data associated with each data element that includes a corresponding data collection feature. Data associated with the usage of the data element may be stored in the data records, and subsequently collected by a publisher or an advertiser via the Internet. FIG. 5 illustrates a flowchart 500 illustrating an exemplary data collection technique consistent with certain disclosed embodiments.

The data collection process may be initiated when a user displays the electronic publication (Step 510). Upon initialization, one or more data files associated with data collection features may be initialized to record data corresponding to user interaction associated with the feature (Step 520). According to one aspect, data corresponding to user interaction may include an amount of time that a user views a particular ad or interacts with a particular feature. For example, during a video advertisement, a time that a user allows an advertisement to run may be recorded. Alternatively, some interactive advertisements may allow a user to interact with the advertisement using a mouse or pointing device. The time that a user interacts with the ad may be recorded. It is contemplated that certain user activities may be weighted in such a manner so as to make a counting device count faster for different levels of interaction with an asset or feature. For example, simply allowing a particular advertisement to run may cause a counting device to increment at a slower rate that an activity that requires a user to physically interact with the feature using a mouse or pointing device. By weighting the level of user interaction in this manner, publishers and advertisers may be able to determine the effectiveness of a particular ad, based on the type of ad that is displayed, and a level of user responsiveness to the ad.

Once the interaction data has been collected, the data may be provided, via communication link 130 to publication server 120 (Step 530). Publication server 120 may compile interaction data associated with each feature of a particular publication. According to one embodiment, interaction data may be automatically uploaded by a plurality of client devices, via the Internet, to the publication server 120. Publication server 120 may analyze the data and compile a report, a copy of which may be provided to a subscriber of the data (e.g., a publisher or advertiser) (Step 540). As a result, publishers and advertisers may use the data collection methods associated with an electronic publication to estimate demographic data associated with a target audience and/or analyze advertisement effectiveness for a particular target audience.

It is contemplated that, according to one embodiment, the data collection process may be adapted to record user interaction with one or more features of the electronic publication when the user is offline. In this embodiment, the electronic publication may be uploaded or downloaded onto a storage device associated with a particular client device, for offline viewing. When opened by the user, the electronic publication may record data indicative of a user interaction with a particular feature (e.g., article, advertisement, etc.) and store the recorded data in an offline (e.g., temporary) file associated with the particular feature. During subsequent connections with a communication network, such as the internet, this data may be uploaded to publication server 120.

It is also contemplated that publication server 120 may include one or more other applications, programs, or processes that cooperate with the presently disclosed system 100 for analyzing, recording, and compiling user interaction data in order to valuate advertising associated with one or more electronic publications. These programs may be configured to determine, for example, a target demographic associated with a particular electronic publication; a value associated with a particular advertising space in the electronic publication, based on features associated with electronic publication (e.g., a demographic associated with the audience, average length of time viewed by an audience, etc.); and a total cost of advertising, based on user interaction data associated with an ad. Based on this data, advertisers and publishers may be able to more effectively tailor content and/or direct advertising resources to a particular target audience.

Industrial Applicability

Although methods consistent with the disclosed embodiments are described in relation to creating electronic publications based on commercial periodicals and magazines, the disclosed methods may be implemented in any situation where it may be advantageous to create an electronic publication that can be displayed using any standard web-browser, without requiring third-party media players. According to one embodiment, the presently disclosed method may be implemented to generate electronic publications that contain mixed-media content that may be displayed using only standard web-browser technology. As a result, in addition to eliminating the necessity for downloading and running third-party multimedia software view a particular feature of a publications, the presently disclosed methods may allow users to create electronic publications that may be displayed on devices which may not support certain third-party software applications (e.g., televisions, video-game consoles, cell-phones, etc.).

The presently disclosed methods for generating electronic publications may have several advantages. For instance, by creating electronic publications that may be viewed using only a standard web-browser, the presently disclosed method may limit the need for third-party multimedia players. Additionally, because the presently disclosed methods may collect user interaction data associated with the publication, content creators may have access to valuable metrics related to the target audience associated with a particular publication or advertisement. These metrics may be used to modify/enhance content more appropriately connect with the target audience, which may increase circulation and advertising effectiveness.

It will be apparent to those skilled in the art that various modifications and variations can be made to the disclosed methods for creating electronic publications. Other embodiments of the present disclosure will be apparent to those skilled in the art from consideration of the specification and practice of the present disclosure. It is intended that the specification and examples be considered as exemplary only, with a true scope of the present disclosure being indicated by the following claims and their equivalents.

What is claimed is:

1. A method for creating an electronic publication comprising:
importing one or more data assets;
identifying one or more features associated with one or more of the data assets;
converting each data asset and any features associated with each data asset to a browser-readable file format;
arranging one or more of the data assets based on a user-defined layout;
creating a browser-compatible file map of the data assets based on the user-defined layout; and
generating an electronic publication associated with the file map, the electronic publication including browser-readable code that, when executed by a web-browser, displays the one or more data assets and any features associated with each data asset in accordance with the user-defined layout.

2. The method of claim 1, further including storing the electronic publication on a publication server, wherein the publication server enables designated users to access the electronic publication.

3. The method of claim 1, wherein the one or more data assets include one or more of a video data file, audio data file, text data file, or image data file.

4. The method of claim 1, wherein importing one or more data assets includes:
collecting a first data asset associated with a first media type;
collecting a second data asset associated with a second media type; and
merging the first data asset with the second data asset to generate at least a portion of the electronic publication.

5. The method of claim 4, wherein the first data asset includes one or more text or image data files associated with a print publication.

6. The method of claim 4, wherein the second data asset includes one or more video or audio data files associated with a video or audio communication medium.

7. The method of claim 6, wherein the second data asset includes an electronic advertisement associated with one or more of a radio, television, or Internet communication medium.

8. The method of claim 1, further including:
collecting data indicative of a user interaction with one or more of the data assets; and
reporting the data indicative of the user interaction to a subscriber.

9. The method of claim 8, wherein collecting data indicative of the user interaction includes recording a time indicative of the user interaction associated with one or more of the data assets.

10. The method of claim 1, further including:
collecting data indicative of a user interaction with one or more features associated with a particular data asset; and
reporting the data indicative of the user interaction to a subscriber.

11. The method of claim 10, wherein collecting data indicative of the user interaction includes recording a time indicative of the user interaction associated with one or more features of a particular data asset.

12. A computer-readable medium for use on a computer system, the computer-readable medium having computer-executable instructions for performing the method of claim 1.

13. A method for generating interactive electronic publication comprising:
importing one or more data assets;
identifying one or more features associated with one or more of the data assets;
converting each data asset and any features associated with each data asset to a browser-readable file format;
arranging one or more of the data assets based on a user-defined layout;
embedding a data collection feature within one or more of the data assets, wherein the data collection feature is configured to collect data indicative of a user interaction with a designated portion of the data asset; and
generating an electronic publication that, when executed by a web-browser, displays the one or more data assets and any features associated with each data asset in accordance with the user-defined layout.

14. The method of claim 13, further including storing the electronic publication on a publication server, wherein the publication server provides an interface for designated users to access the electronic publication.

15. The method of claim 13, wherein the one or more data assets include one or more of a video data file, audio data file, text data file, or image data file.

16. The method of claim 13, wherein importing one or more data assets includes:
collecting a first data asset associated with a first media type;
collecting a second data asset associated with a second media type; and
merging the first data asset with the second data asset to generate at least a portion of the electronic publication.

17. The method of claim 16, wherein the first data asset includes one or more text or image data files associated with a print publication.

18. The method of claim 16, wherein the second data asset includes one or more video or audio data files associated with a video or audio communication medium.

19. The method of claim 18, wherein the second data asset includes an electronic advertisement associated with one or more of a radio, television, or Internet communication medium.

20. The method of claim 13, further including providing the data indicative of the user interaction to a subscriber.

21. A computer-readable medium for use on a computer system, the computer-readable medium having computer-executable instructions for performing the method of claim 13.

22. A method for creating an electronic publication comprising:
importing one or more data assets associated with a print publication;
importing one or more electronic advertisements;
arranging one or more of the data assets and one or more of the electronic advertisements based on a user-defined layout;
inserting one or more interactive features within the arrangement of data assets and electronic advertisements;
converting the arrangement into a vector-based graphical data file;
creating a browser-compatible file map that includes the arrangement of data assets and electronic advertisements; and
generating an electronic publication associated with the file map, the electronic publication including browser-readable code that, when executed by a web-browser, displays the one or more data assets and any features associated with each data asset in accordance with the user-defined layout.
